(19) United States
(12) Patent Application Publication
(10) Pub. No.: US 2018/0308073 A1
(43) Pub. Date: Oct. 25, 2018

(54) COMPUTERIZED SYSTEM FOR RESOURCE DEFICIENCY TRIGGERED DYNAMIC RESOURCE TRANSFER

(71) Applicant: Bank of America Corporation, Charlotte, NC (US)

(72) Inventors: Manu Jacob Kurian, Dallas, TX (US); Joseph Benjamin Castinado, North Glenn, CO (US); Victoria L. Dravneek, Charlotte, NC (US)

(21) Appl. No.: 15/492,390

(22) Filed: Apr. 20, 2017

(51) Int. Cl. G06Q 20/10; G06F 9/50; G06Q 50/18

(52) U.S. Cl. CPC G06Q 20/10; G06Q 50/188; G06F 9/5011

(57) ABSTRACT

Embodiments of the invention are directed to a system, method, or computer program product for resource deficiency triggered dynamic resource transfer. The invention first receives a resource transfer request from a user for a transfer of resources. Upon determining that the resources associated with the requesting user are insufficient to cover the transfer of resources, the system constructs a resource transfer program to arrange for the completion of the resource transfer request by either immediately transferring a comprehensive amount of the requested resource from another source with sufficient resources to fulfill the request or, alternatively, by generating a program for tiered transfer of the deficient resource amount for completion of the requested transfer.

### FIELD OF THE INVENTION

The present invention is generally directed to digitized resource transfers, and more specifically, for calculating and constructing resource transfer programs in response to a determined resource deficiency.

### BACKGROUND

With the proliferation of Internet technology in recent times, people may utilize online systems to complete interactions and/or request resource transfers via networked computer devices such as mobile phones. That said, there are a number of technical problems and limitations that arise when a user needs to request a resource transfer in real-time to complete an interaction despite a resource deficiency associated with the user. In particular, within other systems, optimized resource transfers are not able to be presented to the user within an efficient time frame that is convenient to the user. Instead, the user typically has to wait a length of time and/or travel to another location in order to complete a requested resource transfer to alleviate the deficiency. However, due to the inconvenience introduced to the process, the user may instead decide to simply abandon the interaction, thereby leading to a loss of the potential interaction for all parties involved.

Accordingly, there is a need for a more efficient and dynamic way to quickly and accurately provide a resource transfer in real-time to a user associated with a resource deficiency to allow for an interaction to be completed.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing a system, computer program product, and computer-implemented method for resource deficiency triggered dynamic resource transfer between two users involved in the resource transfer, wherein means for overcoming the resource deficiency may be generated in real-time.

The invention may be exampled by a system which defines a specific embodiment of the invention. The system typically comprises a communication device in communication with a plurality of user devices of a plurality of users over a network such as a wireless Internet network or the like, the plurality of user devices comprising a first user device of a first user and a second user device of a second user. The system further typically comprises a processor, a memory, and a resource transfer module stored in the memory which is executable by the processor. The resource transfer module may be configured to receive a resource transfer request for a transfer of a first resource from a first resource location associated with the first user to a second resource location associated with the second user. After receiving the request for the resource transfer, the system determines if there is a resource deficiency associated with the first user, wherein the first user has insufficient resources to complete the requested transfer. In response to determining the resource deficiency, the system triggers construction of a resource transfer program, wherein the resource transfer program comprises terms for completion of the resource transfer request. Based on the resource transfer program, the system transfers the first resource from the first resource location to the second resource location, thus completing the initially requested resource transfer.

In some embodiments of the invention, constructing the resource transfer program may further comprise constructing a comprehensive resource transfer program. The system first transfers the first resource from a third resource location associated with another entity to the first resource location associated with the first user. The system then generates a resource fulfillment program for repayment of the first resource to the entity from the first user. To complete this, the system automatically transfers at least a portion of a first resource amount from the first resource location to the third resource location based on the resource payment program, wherein the first resource amount is at least equivalent to the first resource.

In some embodiments, constructing the resource transfer program may further comprise constructing a tiered resource transfer program. The system transmits the resource transfer program to the first user and the second user, and in return, receives back approval of the resource transfer program from the first user and the second user. In response to receiving approval of the resource transfer program from both the first user and the second user, the system may execute the tiered resource transfer program by transferring at least a portion of a first resource amount from the first resource location to the second resource location.

In some embodiments, the terms of the tiered resource transfer program between the first user and the second user are negotiated by an entity associated with the first user on behalf of the first user. In some embodiments, approval may not be received from both the first and the second users. Instead, the system may receive an initial denial of the resource transfer program from at least one of the first user and the second user. Based on receiving the initial denial from the at least one of the first user and the second user, the system may recalculate the resource transfer program and revise the terms of the program. Follow recalculation of the resource transfer program, the system may transmit the resource transfer program back to the first user and the second user and receive approval of the resource transfer program from the first user and the second user.

In some embodiments, during construction of the resource transfer program, the system may further establish an operable communication channel to one or more third party systems. Using the established communication channels, the system may then extract product data from the one or more third party systems and generate a datastore stored in the memory comprising the product data. The contents of this datastore may be continuously updated by the system via the established operable communication channel. With the updated information, the system may continuously recalculate the terms for completion of the resource transfer program prior to completion of the resource transfer request based on the product data stored in the datastore, a financial profile of the first user, and a resource transfer program profile.

In some embodiments, during construction of the resource transfer program, the system may generate and automatically fill one or more documents for approval and completion of the resource transfer program and then transmit the one or more documents to the first user device for review and approval by the first user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts an deficiency triggered dynamic resource transfer system environment, in accordance with one embodiment of the present invention;

FIG. 2 depicts a high level process flow for a deficiency triggered dynamic resource transfer, in accordance with one embodiment of the present invention; and

FIG. 3 depicts a high level process flow for constructing and executing a comprehensive resource transfer program, in accordance with one embodiment of the present invention; and

FIG. 4 depicts a high level process flow for constructing and executing a tiered resource transfer program, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

A “user” as used herein may refer to any entity or individual associated with the resource deficiency triggered dynamic resource transfer system. In some embodiments, a user may be a mobile device application user and/or a financial institution customer (e.g., an account holder or a person who has an account (e.g., banking account, credit account, or the like)). In some embodiments, identities of an individual may include online handles, usernames, aliases, family names, maiden names, nicknames, or the like. In some embodiments, the user may be a customer or a merchant involved in a transaction. In some embodiments, the user may be an individual, organization, or the like who is requesting an alternative payment option such as a loan or a structured payment plan.

Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, global positioning system (GPS) devices, or any combination of the aforementioned. A user device may also refer to a point-of-sale device associated with a merchant or other business entity used for completing a transaction. The user device may be used by the user to access the system directly or through application, online portal, or the like.

In accordance with embodiments of the invention, the terms “financial institution” and “financial entity” may be used to include any organization that processes financial transactions including, but not limited to, banks, credit unions, savings and loan associations, investment companies, stock brokerages, assess management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution.

An “account” or “resource location” is the relationship that a user has with an entity, such as a financial institution or bank. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. In some embodiments, the account is maintained by a third-party entity or financial institution. “Resources” may be funds or assets that include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. In some embodiments, “electronic resources” may refer to financial assets, funds, and/or resources that are maintained and stored in an electronic form on computer systems or devices. For example, electronic resources may include funds stored in an online banking account maintained by a financial institution. In some embodiments, electronic funds may also refer to other digital currencies and cryptocurrencies which may be stored on a user device or maintained in an account by a third party. In some embodiments, resources may further comprise coupons, offers, rebates, or discounts that are available to the user.

“Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users.

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information.

A “transaction” or “interaction” refers to any communication between one or more users, one or more financial institutions, and/or other entities monitoring the user's activities. For example, a transaction may refer to a purchase of goods or services, a return of goods or services, a payment transaction, a credit transaction, a resource transfer, or other interaction involving a user's account. In some embodiments, an interaction may further comprise an offer, quote, or estimate provided by an entity, third party, other user, or the like to the user for consideration.

Embodiments of the invention are directed to a system, method, or computer program product for resource deficiency triggered dynamic resource transfer. The system first receives a resource transfer request from a user for a transfer of resources. Upon determining that the requesting user's personal resources are insufficient to cover the transfer of resources, the system constructs a resource transfer program to arrange for the completion of the resource transfer request by transferring the resources from another source (i.e., another account) or by generating a payment plan where the resources may be transferred in installments over a predetermined period of time to gradually complete the transfer. In some embodiments of the invention, the system may be maintained by a financial institution associated with the user, wherein the financial institution via the system may provide the user with the resources necessary to complete the transaction (i.e., a loan) or negotiate terms of a payment plan with a third party on behalf of the user.

While methods of transferring resources between users exist, it can be difficult to complete a resource transfer request for a user with a resource deficiency in real-time at the time of an interaction. There are a number of technical problems and limitations that arise when a user requests a resource transfer to complete an interaction in real-time when presented with a resource deficiency associated with the user. In particular, within the current systems, optimized resource transfers are not able to be presented to the user within an efficient time frame that is convenient to the user for completion of the interaction. For example, the user may be shopping at a merchant location and request a transfer of funds to the merchant to purchase an item, however the user may have insufficient funds to complete the transaction. The user would typically have to wait an undesired length of time and/or travel to another location in order to complete a requested resource transfer to alleviate the deficiency (e.g., travel to a bank to request a loan or apply online), wherein due to the added inconvenience, the user may instead decide to simply abandon the transaction, thereby leading to the user not receiving the item that he/she desires and the merchant losing revenue from the sale. Furthermore, a resource transfer provided to alleviate a resource deficiency may not take into account the most current or real-time information related to the user's financial information, a good or service being purchased, or loan information, wherein the resource transfer eventually received by the user is not optimized based on the most recent conditions and may not be ideal.

The present invention addresses and solves the specific technological problem of how to conveniently provide an immediate, tailored resource transfer to a resource deficient user by continuously monitoring and updating user, product, and loan information and optimally matching the user to products and loans based on the most up-to-date information. Furthermore, the system can complete the normally tedious and time-consuming process of acquiring a loan in real-time within the time frame of an in-progress transaction so that the resource transfer can be used to complete the transaction without added inconvenience to either user. Also, by continuously updating user, product, and loan profiles in real-time instead of requesting and collecting all of the information at once, the system can drastically reduce the time and computer resources (e.g., processing power, memory space, storage space, cache space, electric power, and networking bandwidth) required to construct and provide a loan to the user wherein the loan can be conveniently provided at the time of a transaction. The invention may also leverage machine learning and artificial intelligence systems to further optimize the real-time loan process.

Embodiments of the present invention address the above needs and/or achieve other advantages by providing apparatuses (e.g., a system, computer program product and/or other devices) and methods for deficiency triggered dynamic resource transfers.

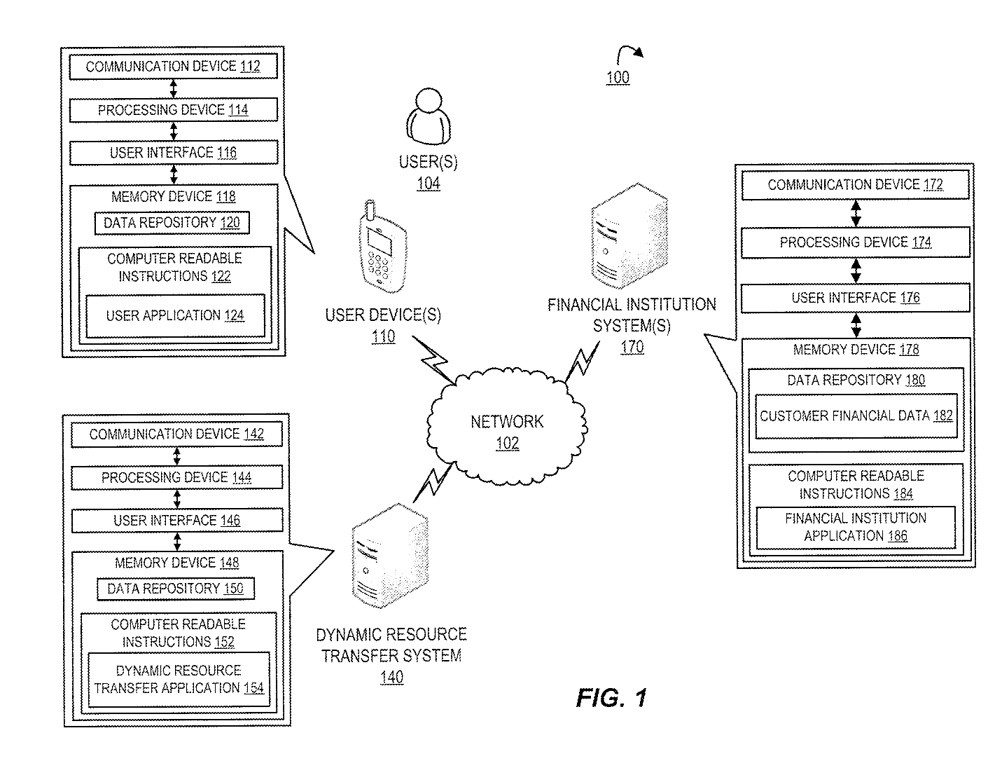

Referring to FIG. 1, the figure illustrates a resource deficiency triggered dynamic resource transfer system environment 100, in accordance with some embodiments of the invention. The environment 100 includes a user device 110 associated and/or used with authorization of a user 104 (e.g., a mobile application user, and the like), a dynamic resource transfer system 140, and a financial institution system 170.

As used herein, a “processing device,” such as the processing devices 114, 144, and 174 generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” such as the user interfaces 116, 146, and 176 generally includes a plurality of interface devices and/or software that allow a customer to input commands and data to direct the processing device to execute instructions. For example, the user interfaces presented in FIG. 1 may include a graphical user interface (GUI) or an interface to input computer-executable instructions that direct the processing device to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” such as memory devices 118, 148, and 178 generally refers to a device or combination of devices that store one or more forms of computer-readable media for storing data and/or computer-executable program code/instructions. Computer-readable media is defined in greater detail below. For example, in one embodiment, the memory device includes any computer memory that provides an actual or virtual space to temporarily or permanently store data and/or commands provided to the processing device when it carries out its functions described herein.

As used herein, a “communication interface” generally includes a modem, server, transceiver, and/or other device for communicating with other devices on a network, and/or a user interface for communicating with one or more customers. Referring again to FIG. 1, the communication devices 112, 142, and 172 comprise communication interfaces having one or more devices configured to communicate with one or more other devices on a network, such as a mobile device, a personal computing device, a mobile banking system, other financial institution banking systems, third party systems, and/or the like. The processing device is configured to use the network communication device to transmit and/or receive data and/or commands to and/or from the other devices connected to the network. Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

The systems and devices communicate with one another over the network 102 and perform one or more of the various steps and/or methods according to embodiments of the disclosure discussed herein. The network 102 may include a local area network (LAN), a wide area network (WAN), and/or a global area network (GAN). The network 102 may provide for wireline, wireless, or a combination of wireline and wireless communication between devices in the network. In one embodiment, the network 102 includes the Internet.

The user device 110 includes a communication device 112 communicably coupled with a processing device 114, which is also communicably coupled with a memory device 118. In some embodiments, the communication device 112 may also comprise a GPS transceiver capable of determining a geographic location associated with the user device 110. The processing device 114 is configured to control the communication device 112 such that the user device 110 communicates across the network 102 with one or more other systems. The processing device 114 is also configured to access the memory device 118 in order to read the computer readable instructions 122, which in some embodiments includes a user application 124. The user application 124 allows for communication of the user device 110 with the other systems and devices within the environment 100 such as the dynamic resource transfer system 140, and financial institution system 170. The user application 124 allows the user 104 to receive information transmitted as well as input information requested by the other systems and communicate with a financial institution, one or more third parties, and/or other entities. In some embodiments, the user application 124 further allows the user to interact with manipulate the user application 124 via the user device 110 in order to request a resource transfer or a loan. The memory device 118 also includes a data repository 120 or database for storing pieces of data that can be accessed by the processing device 114.

The dynamic resource transfer system 140 includes a communication device 142 communicably coupled with a processing device 144, which is also communicably coupled with a memory device 148. The processing device 144 is configured to control the communication device 142 such that the dynamic resource transfer system 140 communicates across the network 102 with one or more other systems. The processing device 144 is also configured to access the memory device 148 in order to read the computer readable instructions 152, which in some embodiments includes a dynamic resource transfer application 154. The dynamic resource transfer application 154 allows for communication with the other systems and devices within the environment 100 such as the user device 110 and the financial institution system 170. The memory device 148 also includes a data repository 150 or database for storing pieces of data that can be accessed by the processing device 144. In some embodiments, the data repository 150 further comprises a repository of product information extracted from other entities such as third party systems (not shown). In some embodiments, the interaction manipulation system 140 may be part of the financial institution systems 170 or the user device 110.

As illustrated in FIG. 1, in one embodiment of the invention, the financial institution system 170 includes a processing device 174 operatively coupled to a network communication device 172 and a memory device 178. The financial institution system 170 includes a communication device 172 communicably coupled with a processing device 174, which is also communicably coupled with a memory device 178. The processing device 174 is configured to control the communication device 172 such that the financial institution system 170 communicates across the network 102 with one or more other systems. The processing device 174 is also configured to access the memory device 178 in order to read the computer readable instructions 184, which in some embodiments includes a financial institution application 186. The financial institution application 186 allows for communication with the other systems and devices within the environment 100 such as the user device 110 and the dynamic resource transfer system 140. The memory device 178 also includes a data repository 180 or database for storing pieces of data that can be accessed by the processing device 174.

The user application 124, the dynamic resource transfer application 154, and the financial institution application 186 are for instructing the processing devices on their respective systems to perform various steps of the methods discussed herein, and/or other steps and/or similar steps. In various embodiments, one or more of the various applications discussed are included in the computer readable instructions stored in a memory device of one or more systems or devices other than their respective systems and/or devices. For example, in some embodiments, the dynamic resource transfer application 154 is stored and configured for being accessed by a processing device of the financial institution system 170 connected to the network 102. In various embodiments, the user application 124, the dynamic resource transfer application 154, and the financial institution application 186 are stored and executed by different systems/devices. In some embodiments, the discussed applications may be similar and may be configured to communicate with one another. In some embodiments, the various applications may be considered to be working together as a singular application despite being stored and executed on different systems.

In various embodiments, one or more of the systems discussed above, such as the financial institution system 170, may be embodied as more than one system and the various components of the system are not collocated, and in various embodiments, there are multiple components performing the functions indicated herein as a single device. For example, in one embodiment, multiple processing devices perform the functions of the processing device 174 of the financial institution system 170 described herein.

In various embodiments, the user device 110, the dynamic resource transfer system 140, the financial institution system 170, and/or other systems may perform all or part of a one or more method or process steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

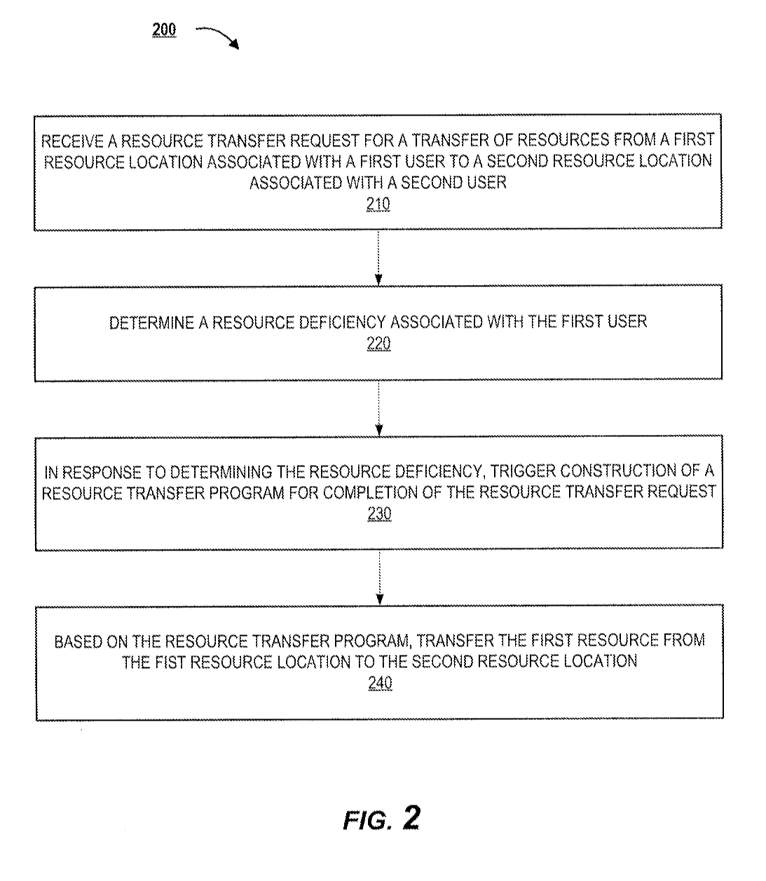

Referring now to FIG. 2, a high level process flow for a deficiency triggered dynamic resource transfer 200 is provided, in accordance with one embodiment of the present invention. This process 200 may be performed by the system described herein (e.g., by the dynamic resource transfer system 140). Initially, at block 210 of FIG. 2, the system first receives a resource transfer request for a transfer of resources from a first resource location associated with a first user to a second resource location associated with a second user. For example, a first user (i.e., a customer) may be requesting completion of a transaction at a merchant location with a second user (i.e., the merchant) and may request for a transfer of funds from an account associated with the first user to an account associated with the merchant. In some embodiments, the request is received by the system in response to the initiation of a transaction. A transaction may be initiated, for example, via a user device associated with the first (e.g., a mobile device, computer, or the like) or a user device associated with the second user (e.g., a point of sale device, mobile device, or the like). In some embodiments, initiation of a transaction and request for a resource transfer triggers a sending of the request to an entity (e.g., a financial institution) associated with the requesting user's account. The request may be transmitted to the entity's system over a network via one or more user devices associated with the first and/or second users. In some embodiments, at least one of the first and second users may not be aware of the resource transfer request sent to the entity.

As used herein, a “resource transfer”, “interaction,” or “transaction”, may refer to any activities or communication between a user and an entity (e.g., a financial institution, a merchant, or the like), activities or communication between multiple entities/users, communication between technology applications and the like. A resource transfer may refer to a payment, processing of funds, purchase of goods or services, a return of goods or services, a payment transaction, a credit transaction, or other interactions involving a user's resource or account. In the context of a financial institution or a resource entity such as a merchant, a resource transfer may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, a user requesting or applying for a loan, or any other interaction involving the user and/or the user's device that invokes or is detectable by the financial institution. A resource transfer may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, “resource transfer,” an “interaction,” or a “transaction” refers to any activity initiated between a user and an entity such as a merchant, between the user and a financial institution, or any combination thereof. In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a purchase for a product, service, or the like from a merchant. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures, and the like.

As used herein, a requesting user (typically the “first user” as used herein) may refer to a user or entity within the dynamic resource transfer system that requests a resource transfer to one or more other users or entities within the dynamic resource transfer system. As used herein, a “resource transfer request”, or “transaction request” may refer to the request submitted to the dynamic resource transfer system by a requesting user for a transfer of resources. The resource transfer request may comprise a specified resource (e.g., a specific good or service) requested by the requesting user. In some embodiments, the resource transfer request may further comprise resource or product data associated with a requested resource (e.g., UPC, SKU, barcode, resource description or identifier, or the like). The resource transfer request may further comprise data associated with the requesting user, such as a geographic location (e.g., address, area code, or the like), contact information (e.g., name, phone number, email address, business card), an offer for payment or a bid, or financial information (e.g., credit/debit card information, banking account information, a digital check, a generated payment token, financial account information, or other payment or payment routing information).

In some embodiments, the system (e.g., the dynamic resource transfer system) may receive a resource transfer request from a user device over a network such as in a system environment similar to the environment 100 described in FIG. 1. The resource transfer request may be initiated from an application on a user device associated with the requesting user (e.g., the user application) and transmitted over a network to a computing system or server (e.g., dynamic resource transfer system) where the request may be received by the system and processed by an application (e.g., the dynamic resource transfer application) for presentation to a user or entity.

At block 220 of FIG. 2, the system next determines a resource deficiency associated with the first user after receiving the resource transfer request. As used herein, a “resource deficiency” may refer to a lack or insufficient amount of resources associated with a user, wherein the user does not have a sufficient amount of resources needed to complete a requested resource transfer or transaction. The system may determine a resource deficiency by accessing or retrieving information or data from one or more resource locations associated with a user. For example, upon receiving a resource transfer request for $1000 from a first user, the system may access one or more resource locations (i.e., accounts) associated with the first user and determine that the one or more resource locations associated with the first user only contain $800.

In some embodiments, the system may monitor one or more resource locations, historical resource transfers, and/or scheduled or regular resource transfers (e.g., scheduled bill payments, rent, subscription charges, automatic income deposits, and the like) associated with a user to determine a resource deficiency. The system may further use the monitored information to predict a future resource deficiency that would result from completion of a requested resource transfer. For example, upon receiving a resource transfer request for $1000 from a first user, while a first resource location associated with the first user may contain $1200, the system may determine a predicted resource deficiency based on identifying a regular payment of $300 that is scheduled to be paid on the same day. In some embodiments, the system generates and stores a user profile on the dynamic resource transfer system, wherein the user profile comprises personal information (e.g., name, address, phone numbers, social media information, and the like) and financial information (e.g., income, assets, holdings, debt, credit scores, jobs, and the like) associated with the user. The system may access, reference, and continuously update the user profile in order to determine resource deficiencies and provide resource transfer programs to the user. In some embodiments, the system continuously monitors and updates information contained within the user profile.

The system may further generate a resource or product profile associated with one or more resources, products, or services available to a requesting user. The system may generate profiles for one or more resources or products and store the profiles in a database or datastore stored in the memory of the system. In some embodiments, the system establishes an operable communication channel to one or more third party systems for the extraction of resource or product data from the one or more third party systems. Product data extracted by the system may comprise product descriptions, model and item numbers, types, SKUs, UPC, barcodes, manufacturer information, prices, resale values, longevity, ratings or reviews, cost of ownership, or other descriptive information associated with one or more products. Upon extraction of product data, the system updates the datastore with the extracted information. In some embodiments, the system continuously extracts up-to-date product information and updates the datastore with the most recent information to provide the most current details associated with a product. In some embodiments, the system establishes communication with a third party system and extracts current product information associated with a first resource or product (i.e., good or service) upon a user initiating a transaction or requesting a resource transfer involving the first resource or product. In this way, the system may provide the user with the most accurate determination of a potential resource deficiency. The system may calculate and generate a product score or rating associated with each product that has information stored in the datastore based on the product profiles, wherein the product score represents an overall value to the customer. The system may display a product score to a user via a user device to allow the user to make a more informed decision.

At block 230 of FIG. 2, the system triggers construction of a resource transfer program for completion of the resource transfer request in response to determining the resource deficiency. As used herein, a “resource transfer program” may refer to a program or plan to allow for completion of a resource transfer despite a determined resource deficiency. A resource transfer program may be a loan of resources provided by an entity (e.g., a financial institution) to a requesting user that does not have sufficient funds (i.e., a resource deficiency) to complete a transfer of resources without assistance. In some embodiments, a loaned resource amount may be provided to a user by a financial institution associated with the user. In other embodiments, the financial institution providing the loaned resources may not be previously associated with the user. In some embodiments, the financial institution or other entity that provides the loaned resource amount maintains the dynamic resource transfer system. In other embodiments, the dynamic resource transfer system is maintained by an entity other than the entity providing the loan to the user. Construction of a resource transfer program for the user comprises determining terms and conditions for a user's repayment of a loaned resource amount (e.g., loan amount, regular repayment amounts, length of time for repayment, interest rates, and the like). The terms, conditions, and other information associated with the loan or resource transfer program may be stored in a generated loan profile stored in a database or datastore within the dynamic resource transfer system. The system may construct a resource transfer program for the user based on standard loan templates stored in the database. Alternatively, the system may construct a customized resource transfer program by accessing information stored in the user profile, product profiles, and loan profiles. In some embodiments, the system continuously matches the user profile with the product profiles and loan profiles in order to provide an accurate, optimized resource transfer program (i.e., a loan) to the user on demand in real-time that reflects the most current information. In this way, a resource transfer program may be provided to the user quickly and efficiently within the time frame of the user initiating a transaction or requesting a resource transfer.

In some embodiments of the invention, the system may allow for an additional user and associated resource location to contribute to the resource transfer program, wherein the original user and the at least one additional user may operate as a single paying body within the system. The additional user may have cash inflows, total amount of assets, credit history, age, or the like higher than the original user. In this way, a user may be able to obtain more attractive terms and conditions with the aid of the additional user than if the user were requesting the resource transfer alone. For example, a teenager may be attempting to obtain a loan to purchase a car and have his or her parent assist in acquiring the loan to obtain more attractive terms and conditions. In some embodiments, the system may combine contributions from each user into a single contribution (e.g., a down payment, a payment in a payment plan, or the like) as far as a recipient user (i.e., the second user or the merchant) is concerned. In some embodiments, the original user may be the primary owner of the loan and the additional user may be able to check in on the status, progress, or other details (i.e., payments made, payments owed, or the like) associated with the loan. In some embodiments, the additional user may act as a cosigner for the loan.

In some embodiments, the system generates one or more documents (terms and conditions description, signature documents, insurance documents, and the like) necessary for approval and completion of the resource transfer program. The system may automatically generate the one or more documents and transmit the documents to a user device associated with the user or a user device involved in the resource transfer (e.g., a POS device), wherein the documents may be displayed to the user for approval. The system may allow the user to sign or digitally sign the documents and approve of the user's enrollment in the resource transfer program. In some embodiments, the system may automatically fill at least a portion of the one or more documents before displaying the one or more documents to the user to reduce the amount of time required for a user to complete the one or more documents.

At block 240 of FIG. 2, the system transfers the first resource from the first resource location to the second resource location based on the resource transfer program approved by the user. In some embodiments transfer of the first resource initially request by the user completes the resource transfer request of the user. In some embodiments, receiving the user's approval of the resource transfer program triggers the transfer of resources from a first resource location associated with the user to a second resource location associate with a second user (i.e., a merchant). The system receives or withdraws the first resource from the first resource location associated with the first user and transfers the first resource to the second resource location, wherein system transfers or deposits the first resource to a resource storage location (e.g., an account, e-wallet, or the like) associated with the second user. The deposit of the first resource may be an immediate electronic transfer of funds between accounts. In some embodiments, the system may display a notification to at least one of the first and second users that the transfer of resources was completed.

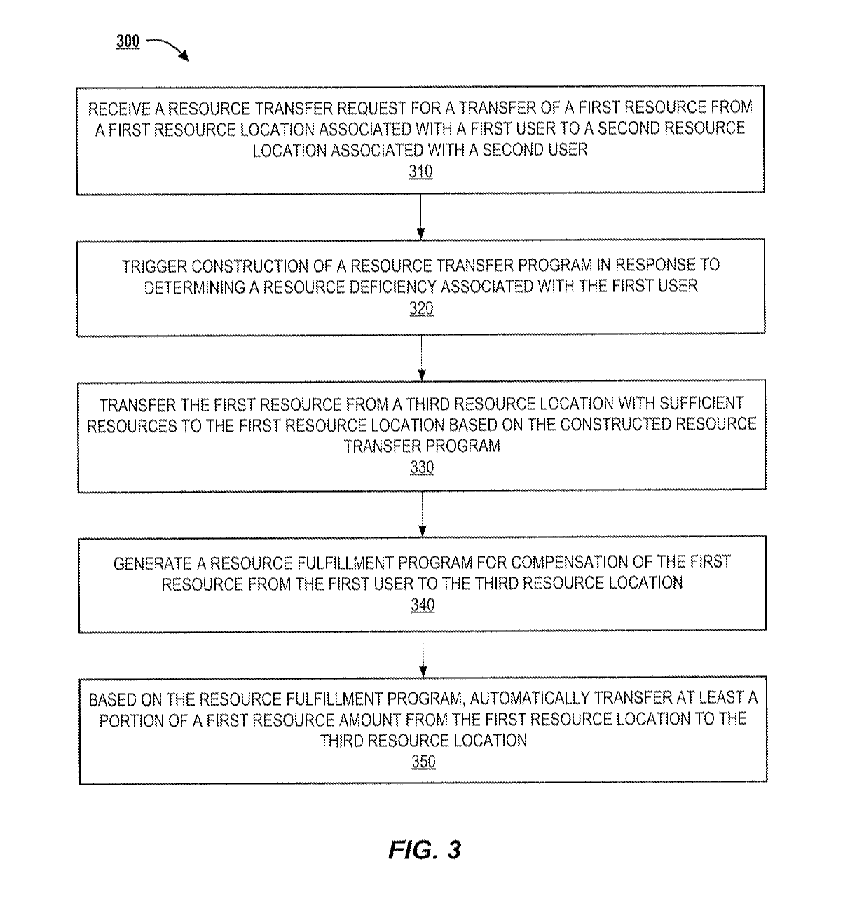

Referring now to FIG. 3, the figure depicts a high level process flow for constructing and executing a comprehensive resource transfer program 300, in accordance with one embodiment of the present invention. In some embodiments, the resource transfer program may be a comprehensive resource transfer program, wherein the first resource is immediately provided in total for completion of the resource transfer request. In blocks 310 and 320, the system first receives a resource transfer request for a transfer of a first resource from a first resource location associated with a first user to a second resource location associated with a second user and triggers construction of a resource transfer program, respectively, similar to the initial steps of FIG. 2 as previously described.

In block 330 of FIG. 3, the system transfers the first resource from a third resource location (i.e., the financial institution) with sufficient resources to the first resource location based on the constructed resource transfer program. In this embodiment of the invention, an entity (e.g., a financial institution) provides or loans at least a portion of the requested first resource amount to the first user for completion of the resource transfer request. In some embodiments, the entity that provides the first resource amount to the first user may not be a financial institution associated with the user. In some embodiments, the system may transfer the first resource directly from the third resource location associated with the financial institution to the second resource location associated with the second user (i.e., a merchant), wherein the financial institution directly completes the requested transaction or transfer of resources instead of the resources first passing through the first resource location associated with the first user. In some embodiments, the second user (i.e., the merchant) may simply receive payment and not be aware of the resource transfer program or loan.

In block 340 of FIG. 3, the system next generates a resource fulfillment program for compensation of the first resource from the first user to the third resource location. The resource fulfillment program may be a payment program or plan for repaying a first resource amount to the financial institution from the first user who used the provided first resource to complete the requested resource transfer. The resource fulfillment program may be generated based on the terms and conditions of a constructed resource transfer program that was previously approved by the first user. In this way, the first user may complete the requested resource transfer despite a resource deficiency and repay the first resource amount gradually. In some embodiments, the resource fulfillment program may be a variable repayment plan, wherein the amount that the user repays is not a regular but rather vary (e.g., frequency of payments, amount of each payment, or the like). The payment plan may depend on a condition of the user, such as the user's inflow and/or outflows, current assets, employment status, medical status, or the like. For example, a user may depend on a seasonal income that varies depending on the time of year. In this example, the user's payments may be higher to coincide with the period of time when the user's income is higher and lower to coincide with the period of time when the user's income is lower. In this way, the user may conveniently repay the loaned resource amount without additional burden.

In block 350 of FIG. 3, the system automatically transfers at least a portion of the first resource amount from the first resource location to the third resource location. In some embodiments, the transferring at least a portion of the first resource amount may comprise automatic and/or scheduled payments as set forth in the resource fulfillment program and/or resource transfer program. In some embodiments, the system continues to transfer resources form the first resource location to the third resource location until the first resource amount has been at least paid back to the third resource location (i.e., the entity that provided the loan).

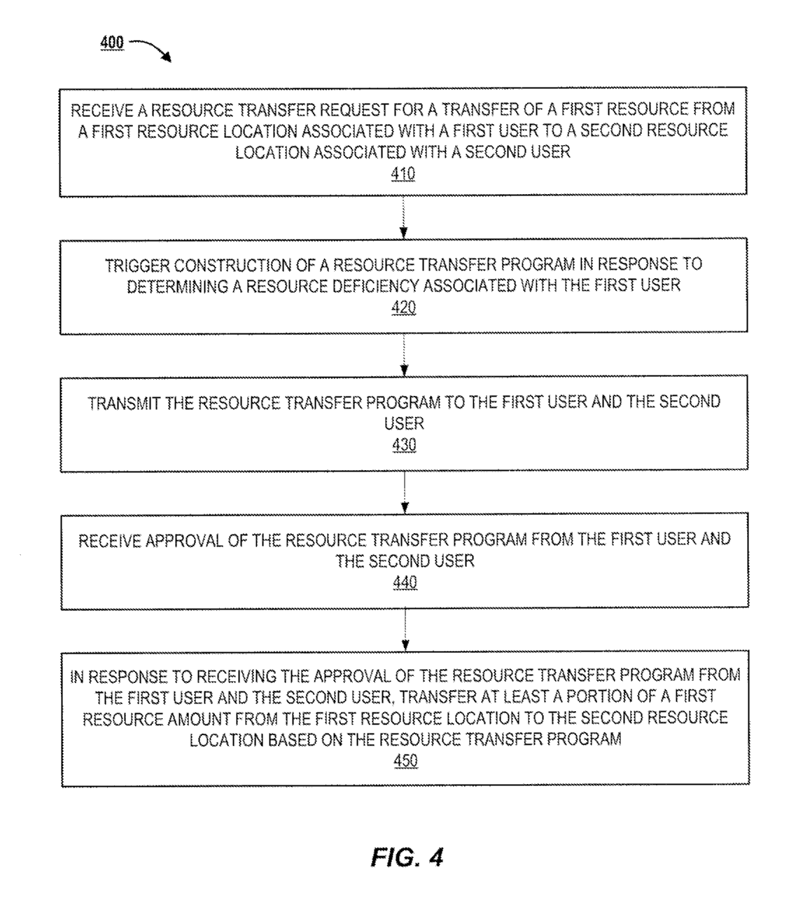

Referring now to FIG. 4, a high level process flow for constructing and executing a tiered resource transfer program 400 is provided, in accordance with one embodiment of the present invention. In some embodiments of the invention, the resource transfer program may be a tiered resource transfer program, wherein a requested resource transfer between a first user (e.g. a customer) and a second user (e.g., a merchant) may be completed gradually over time instead of immediately at the time of a transaction. In some embodiments, an entity such as a financial institution may negotiate or mediate the terms and conditions for completion of the resource transfer.

In blocks 410 and 420, the system first receives a resource transfer request for a transfer of a first resource from a first resource location associated with a first user to a second resource location associated with a second user and triggers construction of a resource transfer program, respectively, similar to the initial steps of FIGS. 2 as previously described. In block 430 of FIG. 4, transmits the resource transfer program to the first user and the second user for review and approval, wherein the transmitted resource transfer program defines the terms and conditions for completion of the requested resource transfer between the first and second users. The system may transmit the resource transfer program and request approval for the program to the first user and the second user via a first user device and a second user device respectively. Alternatively, the system may transmit the resource transfer program and approval request to a merchant device (e.g., a POS device) associated with the second user (i.e., a merchant) wherein both users review and approve the resource transfer program via the merchant device. In some embodiments, the entity is a financial institution associated with the user, wherein the financial institution negotiates the terms and conditions of the resource transfer program with the second user on behalf of the first user. In some embodiments, the financial institution associated with the first user may cosign the resource transfer program with the first user to provide more attractive terms and conditions for its customer (e.g., lower interest rates). In some embodiments, the resource transfer program may be a combination of the cumulative and tiered resource transfer programs, wherein a user pays an initial sum before enrolling in a repayment plan with regular payments.

In block 440 of FIG. 4, the system next receives approval of the transmitted resource transfer program from the first user and second user. In some embodiments, the system must receive approval from both the first and second user in order to execute and implement a resource transfer program. In some embodiments, the system may receive an initial denial of the resource transfer program from at least one of the first user and the second user. Based on receiving the initial denial from at least one of the first user and the second user, the system may recalculate the resource transfer program using the user profile, product profiles, and loan profiles to provide revised terms and conditions for the resource transfer program. The revised terms and conditions may be subsequently transmitted and displayed to the first and second users for approval. In other embodiments, the system may determine based on the user profile, product profiles, and loan profiles to not transmit revised terms and conditions or transmit final terms and conditions for the resource transfer program. For example, the system may determine that a price for a product demanded by a merchant is too high based on the information contained in the product profile for the product and the system cannot further adjust the terms and conditions to meet the merchant's demands. In another example, the system may determine that the user cannot afford further adjustment of the terms and conditions to meet the merchant's demands.

In block 450 of FIG. 4, in response to receiving the approval of the resource transfer program from the first user and the second user, the system transfers at least a portion of a first resource amount from the first resource location associated with the first user to the second resource location associated with the second user based on the approved resource transfer program. Transfers of the resource portions or amounts may be defined by the terms and conditions of the approved resource transfer program.

In some embodiments of the invention, upon initiation of the requested resource transfer in the presence of a resource deficiency, the system may provide the requesting user with the option of selecting a comprehensive resource transfer program or a tiered resource transfer program to complete the requested resource transfer.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource deficiency triggered dynamic resource transfer, the system comprising:
a communication device in communication with a plurality of user devices of a plurality of users over a network, the plurality of user devices comprising a first user device of a first user and a second user device of a second user;
a processor;
a memory; and
a resource transfer module stored in the memory, executable by the processor and configured to:
receive a resource transfer request for a transfer of a first resource from a first resource location associated with the first user to a second resource location associated with the second user;
determine a resource deficiency associated with the first user;
in response to determining the resource deficiency, trigger construction of a resource transfer program, wherein the resource transfer program comprises terms for completion of the resource transfer request; and
based on the resource transfer program, transfer the first resource from the first resource location to the second resource location, wherein the resource transfer request is completed.

2. The system of claim 1, wherein construction of the resource transfer program further comprises:
transferring the first resource from a third resource location associated with a financial institution to the first resource location associated with the first user;
generating a resource fulfillment program for repayment of the first resource to the financial institution from the first user; and
based on the resource payment program, automatically transferring at least a portion of a first resource amount from the first resource location to the third resource location, wherein the first resource amount is at least equivalent to the first resource.

3. The system of claim 1, wherein construction of the resource transfer program further comprises:
transmitting the resource transfer program to the first user and the second user;
receiving approval of the resource transfer program from the first user and the second user; and
in response to receiving the approval of the resource transfer program from the first user and the second user, transferring at least a portion of a first resource amount from the first resource location to the second resource location.

4. The system of claim 3, wherein terms of the resource transfer program are negotiated with the second user by a financial institution associated with the first user on behalf of the first user.

5. The system of claim 3, wherein receiving the approval of the resource transfer program from the first user and the second user further comprises:
receiving an initial denial of the resource transfer program from at least one of the first user and the second user;
based on receiving the initial denial from the at least one of the first user and the second user, recalculating the resource transfer program, wherein the resource transfer program comprises revised terms;
transmitting the resource transfer program to the first user and the second user; and
receiving the approval of the resource transfer program from the first user and the second user.

6. The system of claim 1, wherein construction of the resource transfer program further comprises:
establishing an operable communication channel to one or more third party systems;
in response to establishing the operable communication channel, extracting product data from the one or more third party systems;
generating a datastore stored in the memory comprising the product data;
continuously updating the product data stored in datastore via the established operable communication channel; and
continuously recalculating the terms for completion of the resource transfer program prior to completion of the resource transfer request based on the product data stored in the datastore, a financial profile of the first user, and a resource transfer program profile.

7. The system of claim 1, wherein construction of the resource transfer program further comprises:
generating and automatically filling one or more documents for approval and completion of the resource transfer program; and
transmitting the one or more documents to the first user device for review and approval by the first user.

8. A computer program product for resource deficiency triggered dynamic resource transfer, comprising a non-transitory computer-readable storage medium having computer-executable instructions for:
receiving a resource transfer request for a transfer of a first resource from a first resource location associated with a first user to a second resource location associated with a second user;
determining a resource deficiency associated with the first user;
in response to determining the resource deficiency, triggering construction of a resource transfer program, wherein the resource transfer program comprises terms for completion of the resource transfer request; and
based on the resource transfer program, transferring the first resource from the first resource location to the second resource location, wherein the resource transfer request is completed.

9. The computer program product of claim 8, wherein construction of the resource transfer program further comprises:
transferring the first resource from a third resource location associated with a financial institution to the first resource location associated with the first user;
generating a resource fulfillment program for repayment of the first resource to the financial institution from the first user; and
based on the resource payment program, automatically transferring at least a portion of a first resource amount from the first resource location to the third resource location, wherein the first resource amount is at least equivalent to the first resource.

10. The computer program product of claim 8, wherein construction of the resource transfer program further comprises:
transmitting the resource transfer program to the first user and the second user;
receiving approval of the resource transfer program from the first user and the second user; and
in response to receiving the approval of the resource transfer program from the first user and the second user, transferring at least a portion of a first resource amount from the first resource location to the second resource location.

11. The computer program product of claim 10, wherein terms of the resource transfer program are negotiated with the second user by a financial institution associated with the first user on behalf of the first user.

12. The computer program product of claim 10, wherein receiving the approval of the resource transfer program from the first user and the second user further comprises:
receiving an initial denial of the resource transfer program from at least one of the first user and the second user;
based on receiving the initial denial from the at least one of the first user and the second user, recalculating the resource transfer program, wherein the resource transfer program comprises revised terms;
transmitting the resource transfer program to the first user and the second user; and
receiving the approval of the resource transfer program from the first user and the second user.

13. The computer program product of claim 8, wherein construction of the resource transfer program further comprises:
establishing an operable communication channel to one or more third party systems;
in response to establishing the operable communication channel, extracting product data from the one or more third party systems;
generating a datastore stored in the memory comprising the product data;
continuously updating the product data stored in datastore via the established operable communication channel; and
continuously recalculating the terms for completion of the resource transfer program prior to completion of the resource transfer request based on the product data stored in the datastore, a financial profile of the first user, and a resource transfer program profile.

14. The computer program product of claim 8, wherein construction of the resource transfer program further comprises:
generating and automatically filling one or more documents for approval and completion of the resource transfer program; and
transmitting the one or more documents to the first user device for review and approval by the first user.

15. A computer-implemented method for resource deficiency triggered dynamic resource transfer comprising:
receiving a resource transfer request for a transfer of a first resource from a first resource location associated with a first user to a second resource location associated with a second user;
determining a resource deficiency associated with the first user;
in response to determining the resource deficiency, triggering construction of a resource transfer program, wherein the resource transfer program comprises terms for completion of the resource transfer request; and
based on the resource transfer program, transferring the first resource from the first resource location to the second resource location, wherein the resource transfer request is completed.

16. The computer-implemented method of claim 15, wherein construction of the resource transfer program further comprises:
transferring the first resource from a third resource location associated with a financial institution to the first resource location associated with the first user;
generating a resource fulfillment program for repayment of the first resource to the financial institution from the first user; and
based on the resource payment program, automatically transferring at least a portion of a first resource amount from the first resource location to the third resource location, wherein the first resource amount is at least equivalent to the first resource.

17. The computer-implemented method of claim 15, wherein construction of the resource transfer program further comprises:
transmitting the resource transfer program to the first user and the second user;
receiving approval of the resource transfer program from the first user and the second user; and
in response to receiving the approval of the resource transfer program from the first user and the second user, transferring at least a portion of a first resource amount from the first resource location to the second resource location.

18. The computer-implemented method of claim 17, wherein terms of the resource transfer program are negotiated with the second user by a financial institution associated with the first user on behalf of the first user.

19. The computer-implemented method of claim 17, wherein receiving the approval of the resource transfer program from the first user and the second user further comprises:
receiving an initial denial of the resource transfer program from at least one of the first user and the second user;
based on receiving the initial denial from the at least one of the first user and the second user, recalculating the resource transfer program, wherein the resource transfer program comprises revised terms;
transmitting the resource transfer program to the first user and the second user; and
receiving the approval of the resource transfer program from the first user and the second user.

20. The computer-implemented method of claim 15, wherein construction of the resource transfer program further comprises:
establishing an operable communication channel to one or more third party systems;
in response to establishing the operable communication channel, extracting product data from the one or more third party systems;
generating a datastore stored in the memory comprising the product data;
continuously updating the product data stored in datastore via the established operable communication channel; and
continuously recalculating the terms for completion of the resource transfer program prior to completion of the resource transfer request based on the product data stored in the datastore, a financial profile of the first user, and a resource transfer program profile.
